(19) United States
(12) Patent Application Publication
(10) Pub. No.: US 2009/0295994 A1
(43) Pub. Date: Dec. 3, 2009

(54) VIDEO DISPLAY DEVICE AND METHOD OF TRANSMITTING DATA WITHIN VIDEO DISPLAY DEVICE

(75) Inventor: Masayoshi Kojima, Daito City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/472,448

(22) Filed: May 27, 2009

(30) Foreign Application Priority Data
May 28, 2008 (JP) 2008-138955

(51) Int. Cl. H04N 5/44

(52) U.S. Cl. 348/553; 348/E05.096

(57) ABSTRACT

A video display device includes: a first microprocessor transmitting character string data having a plurality of data elements, each data element including a character code and information on a position in which a character corresponding to the character code is displayed or information on an order in which the character corresponding to the character code is displayed; a second microprocessor receiving the character string data transmitted from the first microprocessor to produce a video signal with the character string data; and a display portion displaying a video according to the video signal produced by the second microprocessor.

This nonprovisional application claims priority under 35 U.S.C. §119(a) on Patent Application No. 2008-138955 filed in Japan on May 28, 2008, the entire contents of which are hereby incorporated by reference.

### BACKGROUND OF THE INVENTION

1. Field of the Invention

The present invention relates to a video display device and a method of transmitting data within a video display device.

2. Description of Related Art

A video display device such as a television set is provided with a CPU (central processing unit, hereinafter a “secondary CPU”) such as for controlling power supply and processing a remote control signal and a CPU (hereinafter a “primary CPU”) for processing data such as video data and audio data. The video display device exchanges data between the secondary CPU and the primary CPU, using serial communication means such as a UART (universal asynchronous receiver transmitter: clock asynchronous serial interface).

When data such as a remote control signal is transmitted from the secondary CPU to the primary CPU, the data to be transmitted is typically ASCII (American standard code for information interchange)-encoded by the secondary CPU and is transmitted by UART communication to the primary CPU. When pieces of data are transmitted, the order in which the pieces of data are transmitted is determined by the secondary CPU, and they are transmitted to the primary CPU according to the determined transmission order. The primary CPU processes data received form the secondary CPU one after another.

Disadvantageously, however, in the data transmission method described above, when the primary CPU fails to satisfactorily receive data transmitted from the secondary CPU due to communication failure such as noise, the primary CPU and the secondary CPU recognize conditions differently.

### SUMMARY OF THE INVENTION

An object of the present invention is to provide a video display device that can prevent two microprocessors from recognizing conditions differently and a method of transmitting data within such a video display device.

To achieve the above object, according to one aspect of the invention, there is provided a video display device including: a first microprocessor transmitting character string data having a plurality of data elements, each data element including a character code and information on a position in which a character corresponding to the character code is displayed or information on an order in which the character corresponding to the character code is displayed; a second microprocessor receiving the character string data transmitted from the first microprocessor to produce a video signal with the character string data; and a display portion displaying a video according to the video signal produced by the second microprocessor. In the present invention, the character includes a digit and a symbol.

To achieve the above object, according to another aspect of the invention, there is provided a method of transmitting data within a video display device, the method including the steps of: making a first microprocessor of the video display device produce character string data having a plurality of data elements, each data element including a character code and information on a position in which a character corresponding to the character code is displayed or information on an order in which the character corresponding to the character code is displayed, and making the first microprocessor transmit the character string data to a second microprocessor of the video display device, the second microprocessor using the data transmitted from the first microprocessor to produce a video signal and outputting the video signal to a display portion of the video display device.

According to the invention, the first microprocessor transmits, to the second microprocessor, the character string data having a plurality of data elements, each data element including a character code and information on a position in which a character corresponding to the character code is displayed or information on an order in which the character corresponding to the character code is displayed. Thus, it is possible to prevent the two microprocessors from recognizing conditions differently.

### BRIEF DESCRIPTION OF THE DRAWINGS

FIG. 1 a block diagram of a television set according to an embodiment of the present invention.

FIG. 2 is a diagram showing part of a manufacturing process of the television set shown in FIG. 1.

FIG. 3 is a diagram showing a procedure for issuing a lock release code.

FIG. 4 is a diagram showing an example of a flow chart on how the television set shown in FIG. 1 is operated.

FIG. 5 is a diagram showing an example of the screen of the television set that requests the input of the lock release code.

FIG. 6 is a diagram showing an example of the screen of the television set in a state where the lock release code is input.

FIG. 7 shows a form of the lock release code when a secondary CPU transmits the lock release code to a primary CPU in the television set shown in FIG. 1.

FIG. 8 shows a conventional form of the lock release code when the secondary CPU transmits the lock release code to the primary CPU.

FIG. 9 is a diagram showing an example of the screen of a television set when a data transmission error occurs while the lock release code is input in the conventional form.

FIG. 10 is a diagram showing an example of the screen of the television set shown in FIG. 1 when a data transmission error occurs while the lock release code is input.

### DETAILED DESCRIPTION OF PREFERRED EMBODIMENTS

An embodiment of the present invention will be described below with reference to the accompanying drawings. Here, a video display device according to the embodiment of the invention will be described by way of example, using a television set that operates normally only when a first lock release code previously stored in a memory agrees with a second lock release code input from an input device. Since a normal purchaser can receive the proper second lock release code at a store or the like, the purchaser can use the television set without problems; since a person who does not purchase it in an authorized manner cannot input the proper second lock release code, they cannot operate it normally. Thus, the television set achieves anti-theft effects.

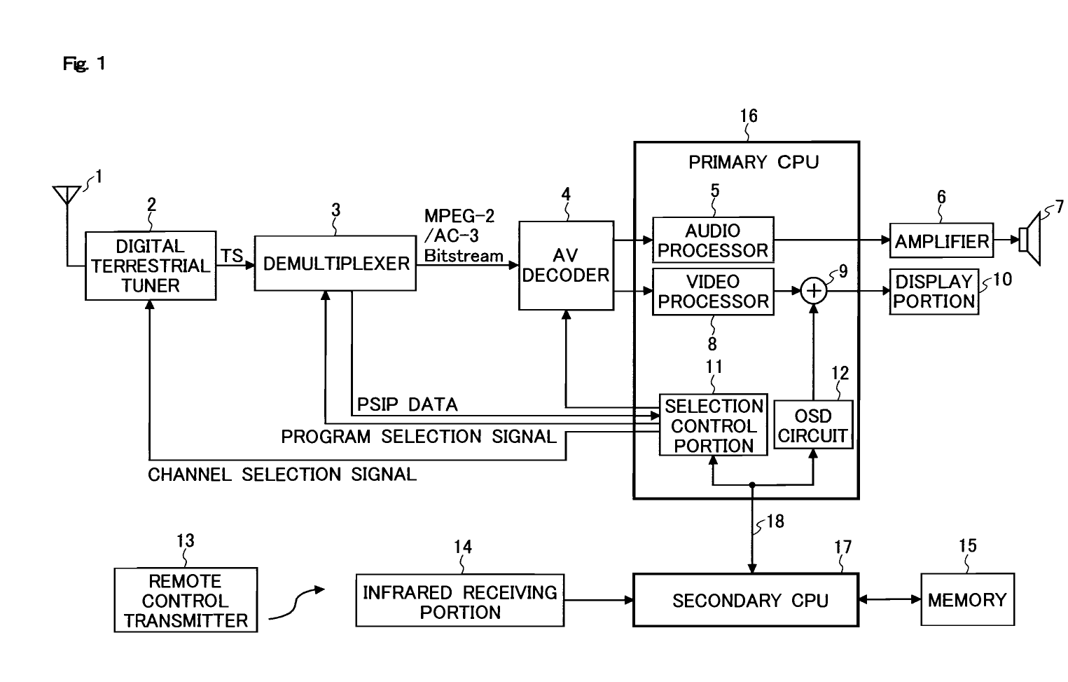

FIG. 1 is a block diagram of a television set 100 according to the embodiment of the invention. In this embodiment, the embodiment will be described using a U.S. digital television set that receives ATSC (advanced television systems committee) signals.

The television set shown in FIG. 1 is provided with two microprocessors, namely, a primary CPU 16 and a secondary CPU 17. The primary CPU 16 is a microprocessor for processing data such as video data and audio data; it is provided with an audio processor 5, a video processor 8, an adder 9, a channel selection control portion 11 and an OSD (on screen display) circuit 12. The secondary CPU 17 is a microprocessor such as for controlling power supply and processing a remote control signal.

A terrestrial antenna 1 receives a digital terrestrial broadcast wave and feeds a received signal to a digital terrestrial tuner 2. The digital terrestrial tuner 2 receives a channel selection signal from the channel selection control portion 11 within the primary CPU 16 to select a physical channel. With this channel selection process, the digital terrestrial tuner 2 converts, into a signal of a specific frequency, a high-frequency 8VSB (8-level vestigial sideband) modulation signal containing video/audio data. The digital terrestrial tuner 2 includes an 8VSB demodulation circuit and the like that demodulate a digital modulation signal through the selected physical channel, and outputs a transport stream TS.

A demultiplexer (DEMUX) 3 divides the transport stream TS received from the digital terrestrial tuner 2 into predetermined packets, namely, a video stream of MPEG-2, an audio stream of AC-3 (“AC-3” refers to a registered trademark by “Dolby Laboratories Licensing Corporation”) and PSIP (program and system information protocol) data. The demultiplexer 3 receives a program selection signal from the channel selection control portion 11 within the primary CPU 16. The demultiplexer 3 feeds the video stream and the audio stream to an AV (audio video) decoder 4, and feeds the PSIP data including program information to the channel selection control portion 11 within the primary CPU 16.

A plurality of virtual channels are multiplexed into the transport stream TS. A VCT (virtual channel table) is collected from the transport stream TS and then a predetermined packet ID is checked by reference to the VCT collected, and this allows any one of the virtual channels to be selected.

The AV decoder 4 is provided with an MPEG video decoder (not shown) that decodes an MPEG-2 bit stream and an AC-3 decoder (not shown) that decodes the audio stream (AC-3 bit stream). Video data produced by the MPEG video decoder in the AV decoder 4 is output to a video processor 8 within the primary CPU 16; audio data is output to an audio processor 5 within the primary CPU 16.

The video processor 8 within the primary CPU 16 receives the video data from the AV decoder 4 and performs D/A conversion to produce an analog video signal. The audio processor 5 within the primary CPU 16 receives the audio data from the AV decoder 4 and performs D/A conversion to produce an analog audio signal.

The OSD circuit 12 within the primary CPU 16 selects, based on an instruction from the secondary CPU 17, a display pattern and outputs a video signal corresponding to the selected display pattern to the adder 9 within the primary CPU 16. The adder 9 within the primary CPU 16 adds a video signal based on bitmap data and the video signal received from the OSD circuit 12 within the primary CPU 16, and feeds the resulting video signal to a display portion (for example, a thin display device that incorporates a drive circuit) 10.

The display portion 10 displays video according to the video signal fed from the video processor 8 within the primary CPU 16. The analog audio signal from the audio processor 5 within the primary CPU 16 is amplified by an amplifier 6, and then a speaker 7 outputs the corresponding sound.

A remote control transmitter 13 is a transmitter that transmits various instructions to the television set. When input keys (not shown in FIG. 1) provided in the remote control transmitter 13 are operated, an infrared remote control signal serving as an instruction corresponding to input of the input keys is transmitted from a light emission portion (not shown). An infrared receiving portion 14 receives the infrared remote control signal, converts the infrared remote control signal into an electrical signal (electrical remote control signal) and feeds the electrical remote control signal to the secondary CPU 17.

The secondary CPU 17 decodes the electrical remote control signal from the infrared receiving portion 14 to obtain a remote control code representing the instruction from the remote control transmitter 13. The secondary CPU 17 transmits, according to the remote control code, data such as a channel switching signal through a communication line 18 such as a UART to the primary CPU 16, and controls the channel selection control portion 11 and the OSD circuit 12 within the primary CPU 16. A memory 15 is a reprogrammable non-volatile memory (such as an EEPROM (electrically erasable and programmable read only memory) or a flash memory) connected to the secondary CPU 17; it stores various types of data including program information, an individual identification number (for example, a serial number), the lock release code and a flag showing whether or not a lock is released (hereinafter, a “lock release flag”).

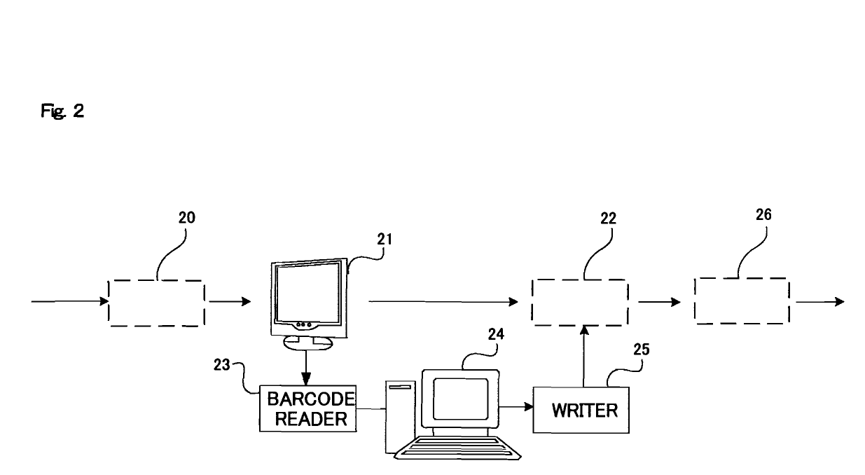

FIG. 2 is a diagram showing part of a manufacturing process of the television set shown in FIG. 1. The individual identification number (for example, a serial number) is given to each television set manufactured in a factory. The individual identification number (for example, a serial number) is given by attaching a barcode representing the individual identification number (for example, a serial number) to the main body of the television set. A code such as a two-dimensional code other than a barcode may be used instead of a barcode.

In this embodiment, a unique individual identification number (for example, a serial number) that is given to each television set in a manufacturing process 20 is stored in the memory 15.

As shown in FIG. 2, the television set that has completed predetermined steps in the manufacturing process 20 is transferred to the subsequent manufacturing process 21. In the manufacturing process 21, the barcode representing the individual identification number (for example, a serial number) attached to the television set is read by a barcode reader 23. Then, the individual identification number (for example, a serial number) is input to a PC (personal computer) 24. The PC 24 has software that produces a lock release code unique to each individual identification number (for example, a serial number). The PC 24 produces the lock release code with the software. The lock release code thus produced is transferred to a writer 25.

In a manufacturing process 22, the lock release code is written, by the writer 25, in the memory 15 in the television set. This writer 25 may be a remote control transmission portion that transmits, as an infrared remote control signal, a signal carrying the lock release code received from the PC 24. The lock release code transmitted from the writer 25 is received by the infrared receiving portion 14 of the television set, and is stored in the memory 15 through the secondary CPU 17 (see FIG. 1). The television set that stores the lock release code is delivered as a product (process 26).

In this way, one lock release code corresponding to one individual identification number is stored in the memory 15 in the television set. Moreover, information corresponding to the lock release code is produced. The individual identification number (for example, a serial number), the information corresponding to the lock release code and the lock release code correspond to each other. The information corresponding to the lock release code and the lock release code are produced such that they agree with each other.

Any method for reading the individual identification number (for example, a serial number) may be employed. For example, an IIC (inter integrated circuit) bus may be used. In this case, the individual identification number (for example, a serial number) that is stored in the memory 15 in the manufacturing process 20 is read through the IIC bus by the PC 24 in the manufacturing process 21.

The lock release code corresponding to the individual identification number (for example, a serial number) is produced by the PC 24, and the lock release code thus produced may be written through the IIC bus in the memory 15 in the television set. The information used for the production of the lock release code is not limited to the individual identification number (for example, a serial number); any other type of information may be used. For example, the manufacturing date of the television set may be used. The method for producing the lock release code is not limited to that shown in FIG. 2; any other method may be used.

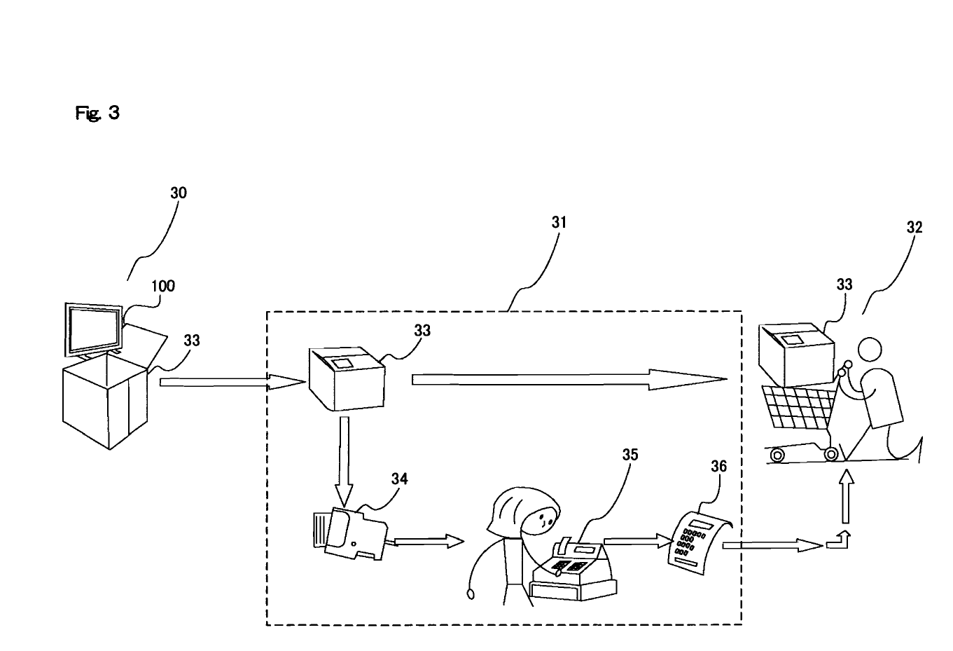

FIG. 3 is a diagram showing a procedure for issuing the information corresponding to the lock release code. In a manufacturing process 30, the television set 100 is packaged. In a sale process 3 1, the bar code representing the individual identification number (for example, a serial number) attached to the packaged television set 33 is read by a barcode reader 34. The read individual identification number (for example, a serial number) is imported into a register device 35. The register device 35 can obtain the information corresponding to the lock release code from each individual identification number (for example, a serial number). The obtained information corresponding to the lock release code is printed on a receipt 36 that shows the record of purchase, and the receipt 36 is handed over to a purchaser (process 32).

It is not always necessary to print the information corresponding to the lock release code on the receipt; any other method for giving it to the purchaser may be used. For example, it may be printed on a sheet that is separate from the receipt. The method for reading the individual identification number (for example, a serial number) is not limited to the method for reading it with a barcode reader; any other method for transferring the information to the register device may be used. For example, the individual identification number (for example, a serial number) may be directly input by a store clerk to the register device. Instead of transferring the individual identification number (for example, a serial number) to the register device, the information corresponding to the lock release code may be obtained by transferring the individual identification number (for example, a serial number) to another device. The timing at which the information corresponding to the lock release code is obtained is not limited.

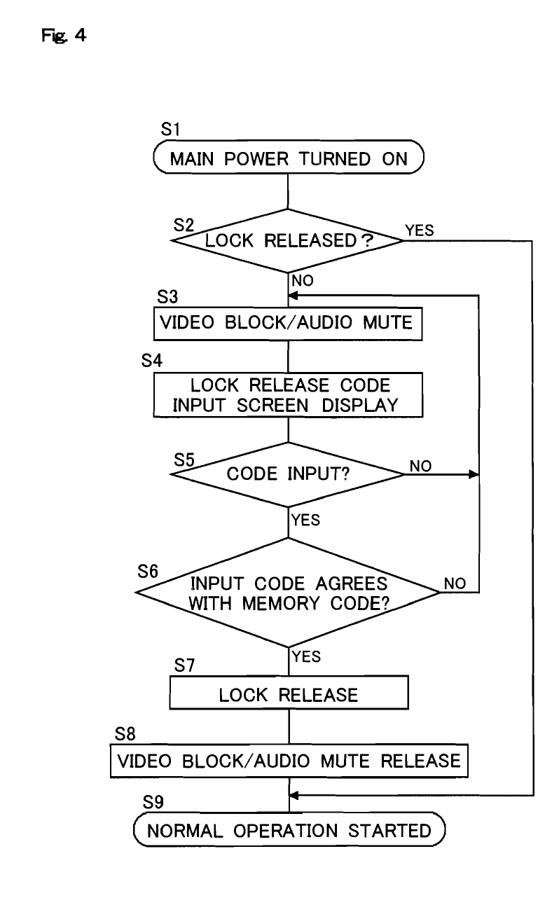

FIG. 4 is a diagram showing an example of a flow chart on how the television set shown in FIG. 1 is operated. The power to the television set is first turned on (step S1), and the secondary CPU 17 in the television set checks whether or not a lock such as a video lock is released based on a lock release flag stored in the memory 15 (step S2). If the lock such as a video lock is found to be already released, the secondary CPU 17 permits the primary CPU 16 to operate normally. Thus, the television set starts the channel selection preset operation, the video display and the audio output (step S9). On the other hand, if the lock such as a video lock is found not to be released yet, the secondary CPU 17 does not permit the primary CPU 16 to operate normally. Thus, the video is blocked and the audio is muted (step S3).

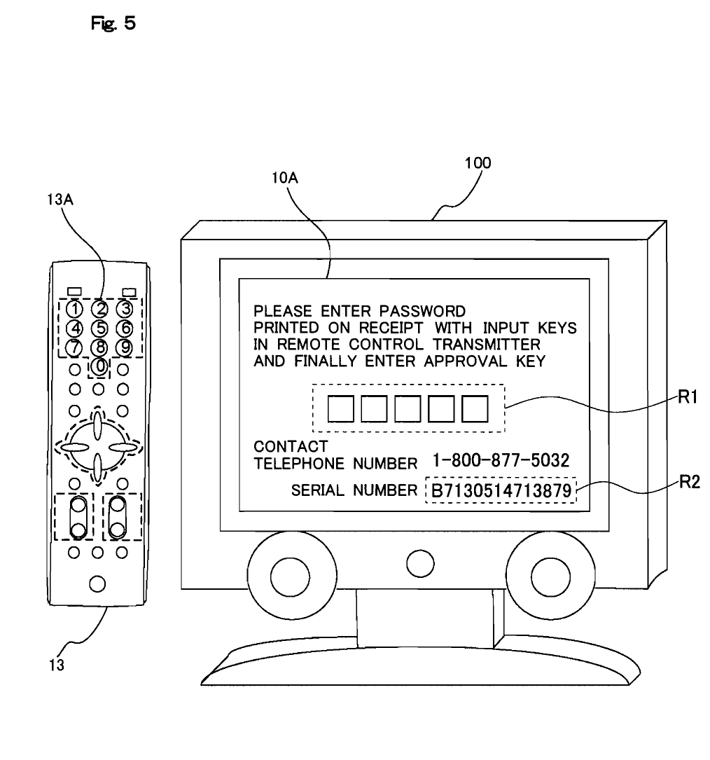

Thereafter, for example, a display requesting the input of the lock release code is produced on the screen of the television set as shown in FIG. 5 (step S4). FIG. 5 shows the television set 100 and the remote control transmitter 13, which is an example of a remote controller. The remote control transmitter 13 has a large number of input keys 13A. The television set 100 has a display screen 10A. The display screen 10A produces a display that says “please enter a password printed on the receipt with the input keys in the remote control transmitter and finally enter an approval key”, a display that says “the contact number is 1-800-877-5032” and a display that says “the serial number is B7130514713879.” A display region R1 shown in FIG. 5 is a region where the lock release code that is input is displayed; a display region R2 shown in FIG. 5 is a region where the individual identification number (for example, a serial number) is displayed.

In step S4, the secondary CPU 17 first transmits, through the communication line 18, both an instruction requesting a display that requires the input of the lock release code and the serial number read from the memory 15 to the OSD circuit 12 within the primary CPU 16, the OSD circuit 12 within the primary CPU 16 selects, according to the instruction of the secondary CPU 17, a display pattern requiring the input of the lock release code among display patters previously stored in an internal memory (not shown), a video signal is produced for displaying the serial number in the display region R2 (see FIG. 5) in the selected display pattern and the video signal produced is output through the adder 9 to the display portion 10. In this way, the display screen 10A in the television set 100 produces a display shown in FIG. 5.

In the example of FIG. 5, as described above, the display “the contact telephone number” and the display “the serial number” are produced. For example, it is likely that the receipt 36 (see FIG. 3) on which the lock release code (password) is printed is lost or soiled by a user and that thus the lock release code (password) becomes illegible. In this case, the user makes a call at “the contact telephone number” to contact a manufacturer and informs them of the serial number, with the result that the user can obtain the lock release code from the manufacturer.

Since the manufacturer produces and stores an internally managed database, when they are informed of the individual identification number (here, the serial number) by the user, they can inform the user of the corresponding lock release code. Moreover, the manufacturer monitors, with the internally managed database, both the individual identification number (here, the serial number) and the associated theft information to know which individual identification number (here, the serial number) is related to the stolen product, with the result that a person who does not purchase it in an authorized manner cannot obtain, even if the person contacts the manufacturer, the lock release code from the manufacture.

In the example of FIG. 5, the serial number is displayed in the region R2 when the screen requesting the input of the lock release code is displayed; the timing at which the individual identification number (for example, a serial number) is displayed is not limited. For example, when the user operates a given special key on the remote control transmitter for displaying the individual identification number, the individual identification number may be displayed.

When the process in step S4 is completed, the user inputs, according to the instruction displayed on the display screen 10A, the information corresponding to the lock release code by use of the remote controller or the like. Here, the television set checks whether or not an input from the user is present (step S5). If no input is found, the video is blocked and the audio is muted (step S3).

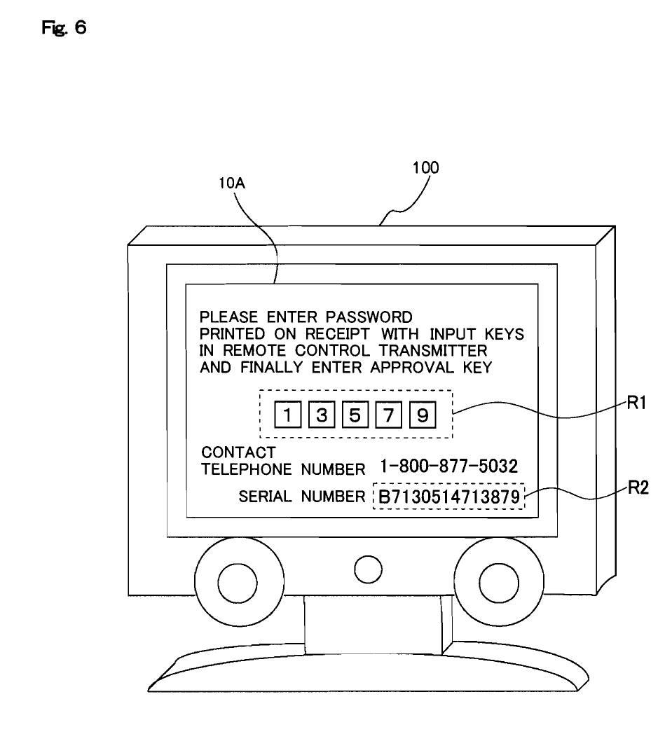

On the other hand, if the information corresponding to the lock release code is found to be input, for example, a display shown in FIG. 6 is produced. Here, a description will be given of a case where five digits are used as the lock release code. The lock release code consists of a first digit, a second digit, a third digit, a fourth digit and a fifth digit which are arranged in this order from left to right in the screen. In the example of FIG. 6, “1” is input as the first digit, “3” is input as the second digit, “5” is input as the third digit, “7” is input as the fourth digit and “9” is input as the fifth digit, and then the result of the input is displayed in the display region R1.

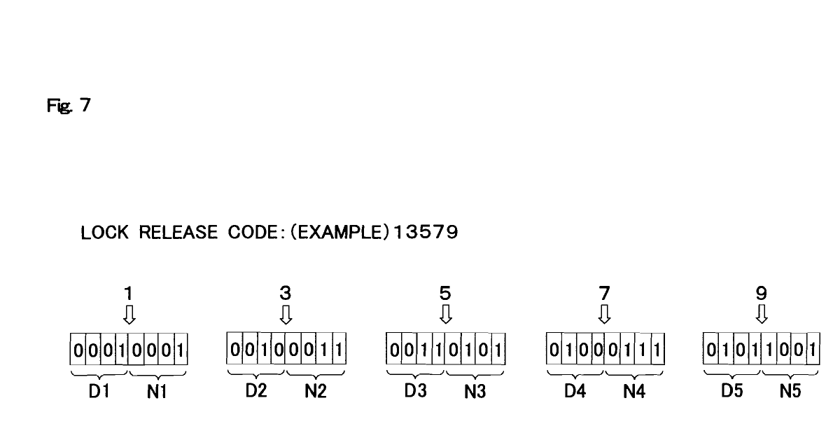

FIG. 7 shows the form of the lock release code when the secondary CPU 17 transmits the lock release code to the primary CPU 16. In this embodiment, as shown in FIG. 7, each digit (each data element) of the lock release code is composed of eight bits; lower four bits are assigned to a character code (which agrees with a binary representation of each digit in this embodiment) (N1 to N5 in FIG. 7) corresponding to a character (any of the digits from 0 to 9 in this embodiment) to be input; higher four bits are assigned to the place of each digit or information (D1 to D5 in FIG. 7) on a position where the character corresponding to the character code is displayed. Since the data element of the first digit “1” is “0001 0001”, it can be represented in hexadecimal notation as “11.” Since the data element of the second digit “3” is “0010 0011”, it can be represented in hexadecimal notation as “23.” Since the data element of the third digit “5” is “0011 0101”, it can be represented in hexadecimal notation as “35.” Since the data element of the fourth digit “7” is “0100 0111”, it can be represented in hexadecimal notation as “47.” Since the data element of the fifth digit “9” is “0101 1001”, it can be represented in hexadecimal notation as “59.”

As described above, one data element is composed of the character code corresponding to the character to be input and the information on the position where the character corresponding to the character code is displayed, and a character string (here, the lock release code) composed of a plurality of data elements is transmitted from the secondary CPU 17 to the primary CPU 16, with the result that the secondary CPU 17 and the primary CPU 16 equally recognize the character code corresponding to the character to be input and the information on the position where the character corresponding to the character code is displayed. In this way, the primary CPU 16 can produce a video signal that allows each character of the character string (here, the lock release code) to be displayed in the correct position without fail. Even when information on an order in which the characters corresponding to the character codes are displayed rather than the information on the position where the character corresponding to the character code is displayed, and the character code corresponding to the character to be input are used as one data element, the similar benefits can be obtained. With respect to the information on the order in which the characters corresponding to the character codes are displayed, for example, the information corresponding to the first digit “1” indicates that it is displayed first, the information corresponding to the second digit “3” indicates that it is displayed second, the information corresponding to the third digit “5” indicates that it is displayed third, the information corresponding to the fourth digit “7” indicates that it is displayed fourth and the information corresponding to the fifth digit “9” indicates that it is displayed fifth.

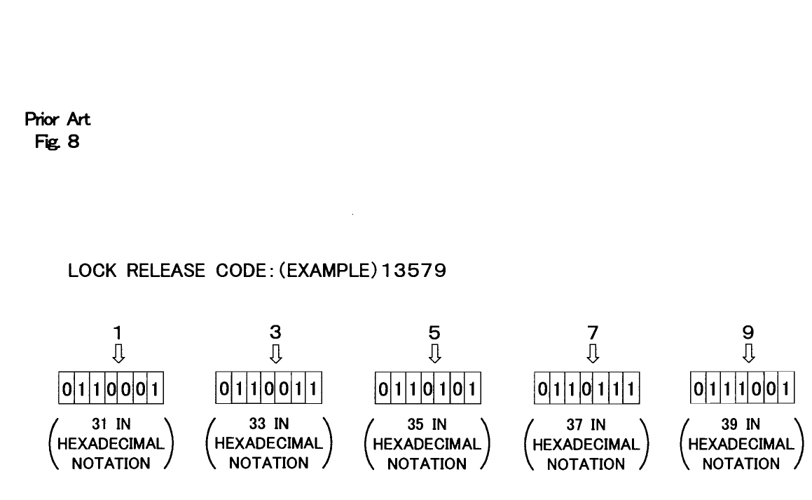

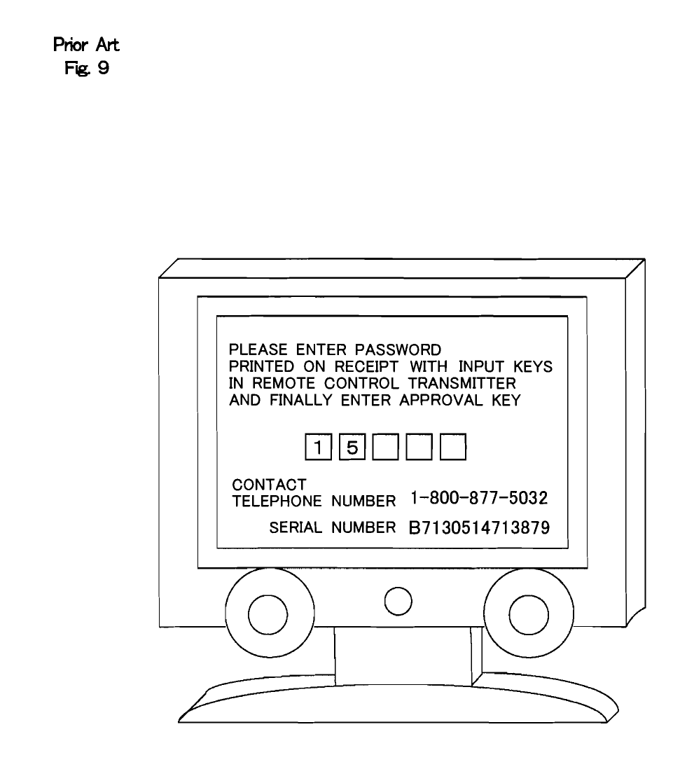

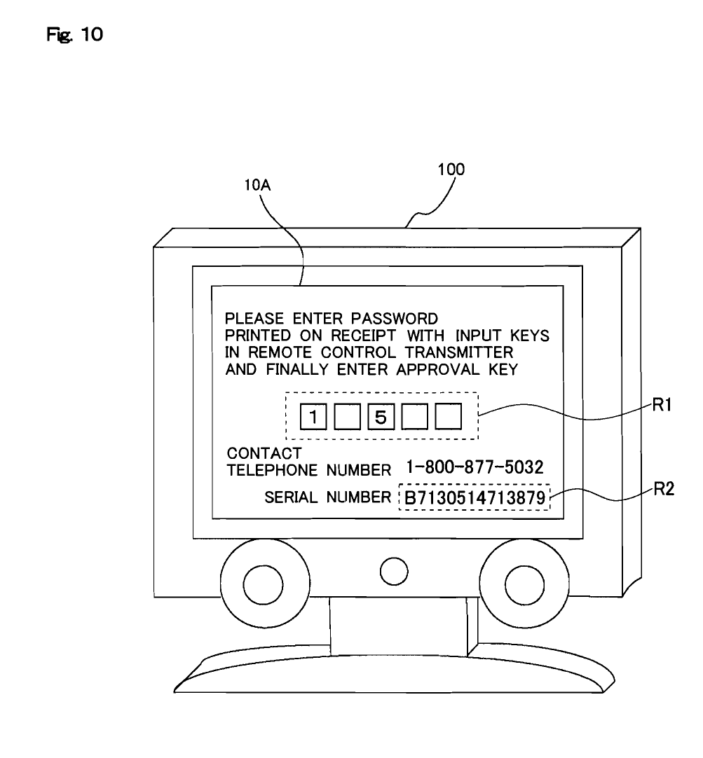

Here, for the purpose of comparison, a conventional method in which the secondary CPU 17 transmits only the information on the characters of the lock release code in the form of an ASCII code to the primary CPU 16 is shown in FIG. 8. When only the information on the characters to be displayed is transmitted in this way, since the primary CPU 16 receives, from the secondary CPU 17, no information on the position where the characters are displayed, for example, if the primary CPU 16 fails to satisfactorily receive the data element of the second digit due to noise or the like, the position where third digit “5” is displayed is disadvantageously displaced to the position where the second digit is displayed, as shown in FIG. 9. In contrast, in this embodiment, even when the primary CPU 16 fails to satisfactorily receive the data element of the second digit due to noise or the like, the third digit “5” is properly displayed in the position where the third digit is to be displayed, as shown in FIG. 10. Then, since a blank is displayed in the position where the second digit is to be displayed, the user immediately finds that a failure occurs when the data element of the second digit is transmitted, with the result that the user can immediately enter the lock release code again.

When the approval key is pressed under conditions shown in FIG. 6, the comparison portion of the television set checks whether or not the information corresponding to the input lock release code agrees with the lock release code stored in the memory 15 (step S6). In this embodiment, the secondary CPU 17 in the television set serves as the comparison portion of the television set.

If the input lock release code is found to agree with the lock release code stored in the memory 15, the video lock and the audio lock are released (step S7). When the locks are released, the blocking of the video and the muting of the audio are released (step S8), and the television set starts the channel selection preset operation, the video display and the audio output (step S9).

On the other hand, if the input lock release code is found not to agree with the lock release code stored in the memory 15, the video is blocked and the audio is muted (step S3).

The means for inputting the lock release code is not particularly limited to the example described above; any other means may be used. For example, instead of the remote controller, input keys provided in the television set may be used such that the secondary CPU 17 controls the primary CPU 16 according to how the input keys provided in the television set are operated.

The timing at which the television set requires the input of the lock release code is not limited. For example, it may be done when the power to the television set is turned on or it may be done a few seconds after the power is turned on.

In the embodiment described above, the form of the lock release code used when the secondary CPU 17 transmits the lock release code to the primary CPU 16 is described in detail; the form of the individual identification number used when the secondary CPU 17 transmits the individual identification number (for example, a serial number) to the primary CPU 16 is preferably the same as the lock release code.

The present invention is not limited to the embodiment described above. For example, although only the television set is described with reference to FIGS. 1 to 10, the description of FIGS. 1 to 10 can apply to a video display device that has no broadcast receiving function, that is, a monitor device.

What is claimed is:

1. A video display device comprising:
a first microprocessor transmitting character string data having a plurality of data elements, each data element including a character code and information on a position in which a character corresponding to the character code is displayed or information on an order in which the character corresponding to the character code is displayed;
a second microprocessor receiving the character string data transmitted from the first microprocessor to produce a video signal with the character string data; and
a display portion displaying a video according to the video signal produced by the second microprocessor.

2. The video display device of claim 1, further comprising:
a memory including a first lock release code;
a comparison portion comparing the first lock release code with a second lock release code that is input by an input device to the first microprocessor; and
a lock control portion releasing, when the comparison by the comparison portion results in agreement, a lock to permit the video display device to operate normally,
wherein the character string data includes data corresponding to the second lock release code.

3. The video display device of claim 1,
wherein the video display device is a television set.

4. A method of transmitting data within a video display device, the method comprising the steps of:
making a first microprocessor of the video display device produce character string data having a plurality of data elements, each data element including a character code and information on a position in which a character corresponding to the character code is displayed or information on an order in which the character corresponding to the character code is displayed, and
making the first microprocessor transmit the character string data to a second microprocessor of the video display device, the second microprocessor using the data transmitted from the first microprocessor to produce a video signal and outputting the video signal to a display portion of the video display device.

5. The method of transmitting data within the video display device according to claim 4,
wherein the video display device includes:
a memory including a first lock release code;
a comparison portion comparing the first lock release code with a second lock release code that is input by an input device to the first microprocessor; and
a lock control portion releasing, when the comparison by the comparison portion results in agreement, a lock to permit the video display device to operate normally, and
the character string data includes data corresponding to the second lock release code.

6. The method of transmitting data within the video display device according to claim 4,
wherein the video display device is a television set.
